(19) United States
(12) Patent Application Publication
(10) Pub. No.: US 2010/0163611 A1
(43) Pub. Date: Jul. 1, 2010

(54) PACKAGING CARTON AND METHOD OF MAKING THE SAME

(76) Inventor: Philippe LeBras, Chateauroux (FR)

Correspondence Address: MEADWESTVACO CORPORATION;ATTN: IP LEGAL DEPARTMENT, 1021 MAIN CAMPUS DRIVE, RALEIGH, NC, 27606, US

(21) Appl. No.: 12/279,559

(22) PCT Filed: Feb. 16, 2007
(86) PCT No.: PCT/US07/62282

§ 371 Date: Aug. 15, 2008

(30) Foreign Application Priority Data
Feb. 16, 2006 (GB) 0603134.8

(51) Int. Cl. B65D 5/02; B31B 3/00; B32B 3/02

(52) U.S. Cl. 229/185.1; 493/162; 428/54

(57) ABSTRACT

A packaging carton manufactured from a pre-shaped blank (10), cut from a flexible sheet of foldable material. The carton has a plurality of panels (A, A1, A2, B, B1, B2, C1, C2, D1, D2, E) and naps (32, 33, 36, 37) separated by fold lines (16 to 31) that define edges of the panels. Selected pairs of the end flaps (36, 37) of the carton incorporate between them a foldable gusset (39) subtended by two converging fold lines (40,41) that converge on a selected fold lines (16, 19). Further selected flaps (32, 33) of the carton (40) are provided with slots (34) each of which is dimensioned and positioned for receiving one of the gussets (39). The gussets (39) are positioned relative to the slots (34) so that the gussets (39) engage in, and are retained by, the respective slots (34) thereby to hold adjacent panels of the carton together.

### FIELD OF INVENTION

This invention relates to packaging cartons, blanks for making packaging cartons, and to a method of making a packaging carton.

### BACKGROUND OF THE INVENTION

Blanks for producing cartons are usually cut or stamped out of thin web of foldable material such as paperboard. An important consideration in the manufacture of blanks from the web material is to optimise the use of the web material, and reduce wastage wherever possible. The usual way of cutting out or stamping out the blanks is to feed a continuous web of the sheet material to a stamping machine and to stamp out successive identical blanks that sit side by side across the web. Often it is not possible to cover the maximum area of the available web material with the templates of the blanks.

An object of the present invention is to provide a carton fabricated from a carton blank with fastening means whereby the panels are held together after the blank is folded.

### SUMMARY OF THE INVENTION

According to one aspect of the invention a carton formed from a blank cut from a flexible sheet of foldable material, the carton comprising a plurality of panels and flaps separated by fold lines that define edges of the panels at least one pair of adjacent flaps having at least one gusset panel hinged there between, at least one of said flaps being provided with a slot which is adapted for receiving the said at least one gusset panel whereby, said at least one gusset panel is retained by the slot thereby holding at least two of said panels of the carton together.

Preferably the carton comprises a linear series of panels for forming a tubular structure and at least one end closure panel hinged to first panel of said linear series of panels for at least partially closing an open end of the tubular structure and a first end closure flap hinged to a second panel adjacent said first panel and wherein the gusset panel is hinged to the first end closure flap for being received in the slot said slot being formed in a second and closure flap.

Preferably the second end closure flap is hinged to a side edge of the end closure panel.

Preferably the first end closure flap is disposed between the second end closure flap and said, second panel.

Preferably the gusset panel is disposed between and hinged thereto to the first end closure flap and a third end closure flap, said first end closure flap being folded into parallel relationship with the second panel and the third end closure flap being folded into parallel relationship with the end closure panel.

Preferably the end closure panel is secured to the third end closure flap.

Preferably the end closure panel is formed from a composite panel comprising a first part hinged to the first panel and second part hinged to a third panel, said first and second panel being secured in overlapping relationship.

Preferably the carton is a gable-end top carton, the slot being provided in an end flap that lies adjacent to a panel that forms a lower end panel of the carton, and the gusset is provided at a selected fold line that defines an upper edge of the lower side panel of the carton.

Preferably the end flap is folded so as to lie inside the lower end panel of the carton thereby to position the slot adjacent a corner of the carton so as to receive the gusset at the corner of the carton when the gusset is pushed into the slot.

Preferably the carton is cube shaped, the slot is provided in an end flap that is are folded to lie adjacent to a panel that forms a sidewall of the carton thereby to position the slot adjacent a corner of the carton, and the gusset is provided at a selected fold lines that defines an upper edge of the carton.

According to another aspect of the present invention there is provided a blank for forming a carton, comprising a plurality of panels and flaps separated by fold lines that define edges of the panels at least one pair of adjacent flaps having at least one gusset panel hinged there between, at least one of said flaps being provided with, a slot which is adapted for receiving the said at least one gusset panel whereby, said at least one gusset panel is retained by the slot thereby holding at least two of said panels of the carton together.

Preferably comprising, in sequence, a bottom flap, a bottom panel with end panels positioned laterally of the bottom panel, a first lower side panel, an upper side panel, a top panel, two top end panels placed laterally of the top panel, a second upper side panel and a lower side panel.

Preferably the bottom end panels each have two flaps and each of the flaps has a slot for receiving one of the gussets when the blank is folded to make a carton.

According to a third aspect of the present invention there is provided a method of manufacturing a packaging carton comprising the steps of:
(a) providing a pre-shaped carton blank cut from a sheet of flexible foldable material having a plurality of panels and flaps separated by fold lines that define edges of the panels, wherein a selected one or more pairs of the flaps incorporate between them a foldable gusset subtended by two converging fold lines a further selected one or more flaps being provided with a slot which is dimensioned and positioned for receiving a gusset, the or each gusset being positioned on the blank relative to a slot so that when the blank is folded about the selected fold lines to form a carton, the or each gusset confronts a respective slot;
(b) folding the blank about the fold lines to bring the or each gusset into confrontation with a respective slot;
(c) inserting the or each gusset into a respective slot to hold adjacent panels of the carton together; and,
(d) gluing selected panels and flaps to selected panels to form a carton.

Preferably a first flap of each of the one or more pairs of flaps is folded through an angle of 180° relative to the plane of the blank and thereby forms a folded gusset and holds the second flap of each pair of flaps in an upright position.

Preferably the carton blank comprises in sequence, a bottom flap, a bottom panel with end panels positioned, laterally of the bottom panel, a first lower side panel, an upper side panel, a top panel, two fop end panels placed laterally of the top panel, a second upper side panel and a lower side panel, and the steps of folding the blank about the fold lines forms a gable-end top carton.

### BRIEF DESCRIPTION OF EXEMPLARY EMBODIMENT INVENTION

An embodiment of the present invention will now be described, by way of example with reference to the accompanying drawings, in which:

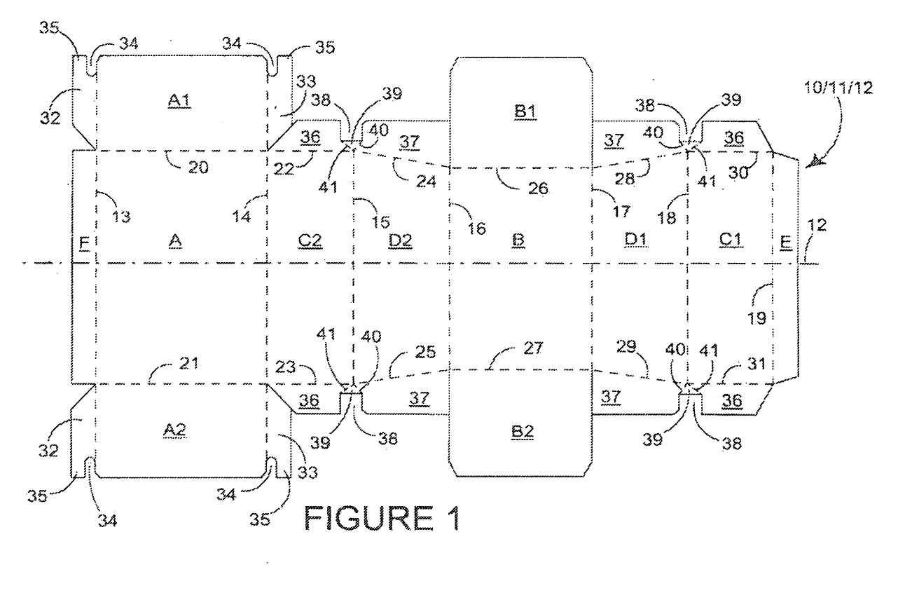

FIG. 1 illustrates the plan view of a canon blank constructed in accordance with the present invention:

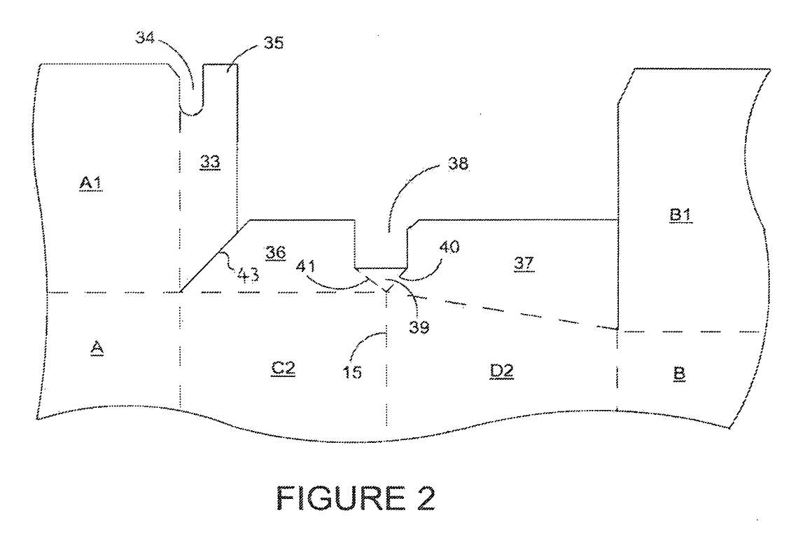

FIG. 2 is an enlarged fragmentary plan view, illustrating in greater detail certain features of the carton blank of FIG. 1; and,

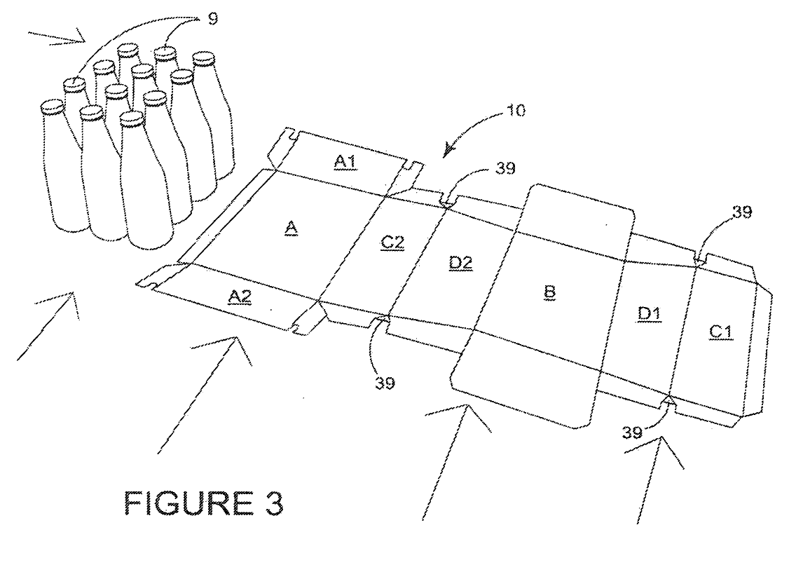

FIGS. 3 to 11 are perspective views showing the steps of a method for manufacturing a packaging carton from a blank constructed in accordance with the present invention.

### DETAILED DESCRIPTION OF THE EXEMPLARY EMBODIMENTS OF THE PRESENT INVENTION

Referring to drawings, and in particular to FIG. 1, there is shown a blank 10, for the manufacture of a secondary packaging carton. The blank 10 is cut from a flexible sheet of material such as foldable paper board and is of symmetrical profile about a central line 12 extending along a first axis. The blank 10 is provided with a set of first fold lines (shown by dotted lines 16 to 31) that define panels of the finished carton which is of the type known as a gable end top carton.

From FIG. 1 if will be seen that the panels comprise in sequence, progressing from left to right of the drawing, a bottom flap F to which a strip of glue is applied, a bottom panel A, two end panels A1, A2 placed laterally of the bottom panel A, a first lower side panel C2, an upper side panel D2, top panel B (that is of smaller area than that of the bottom panel A), two top end panels B1 B2, a second upper side panel D1 and a lower side panel C1.

The bottom end panels A1 and A2 each have a two side flaps 32 and 33, and each of the side flaps 32 and 33 has two slots 34 and two hooks 35 (see FIGS. 1 and 2) the purpose of which will be explained later.

Referring to FIGS. 1 and 2 it will be seen that the upper and lower side panels C2, D2 and C1, D1 each have two end flaps 38, 37 respectively formed out of a single-flap (see FIG. 2). Notches 38 are cut out of the end flaps 36, 37 at a location central to a selected fold fine 16 extending between the upper and lower side panels C2, D2, and a selected fold line 19 extending between the upper and lower side panels C1, D1. Each notch 38 effectively defines one edge of a triangular panel 39 that is subtended by two converging fold lines 40, 41 that converge on the selected first fold lines 15, 18. The panel 39 constitutes a gusset between the end flaps 36, 37. The purpose of the gusset 39 will be explained later.

Referring now to FIGS. 3 to 11 there is shown the steps of a method of manufacturing a packaging carton from a blank 10 shown in FIG. 1. In the example given, the steps are shown schematically. It is to be understood that the steps would be executed automatically using appropriate folding machines and conveyor machines, to transport and fold the carton blank.

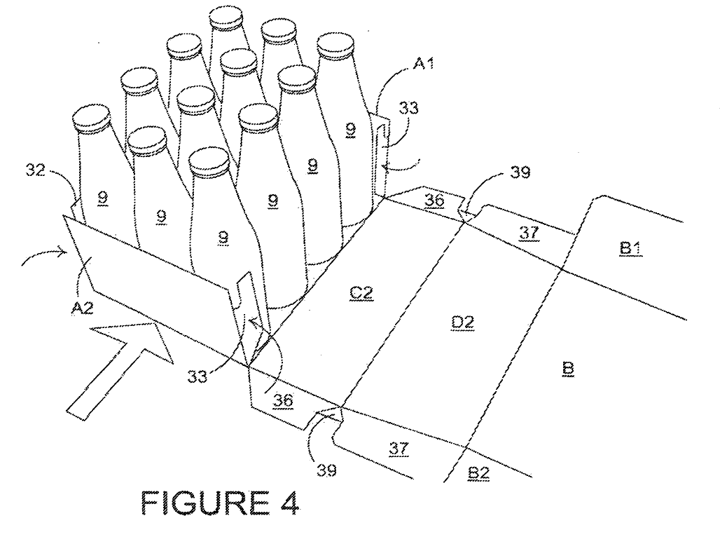

Referring to FIG. 3 there is shown twelve articles 9, such as bottles, for packaging into the carton. An in-feed conveyor (not shown) moves the twelve bottles 9 from left of the drawing towards the right. A blank 10 is offered up to the bottles 9 and positioned with the external printed surface (not shown) of the paper board facing downwards. The blank 10 is aligned with the left hand edge of the blank 10 abutting the bottles 9, and the bottles are moved towards the right to bring them onto the bottom panel A. The end panels A1 A2 are then folded upwards and the side flaps 32, 33 are folded inwards whilst restraining the end panels A1, A2 in an upright position as shown in FIG. 4.

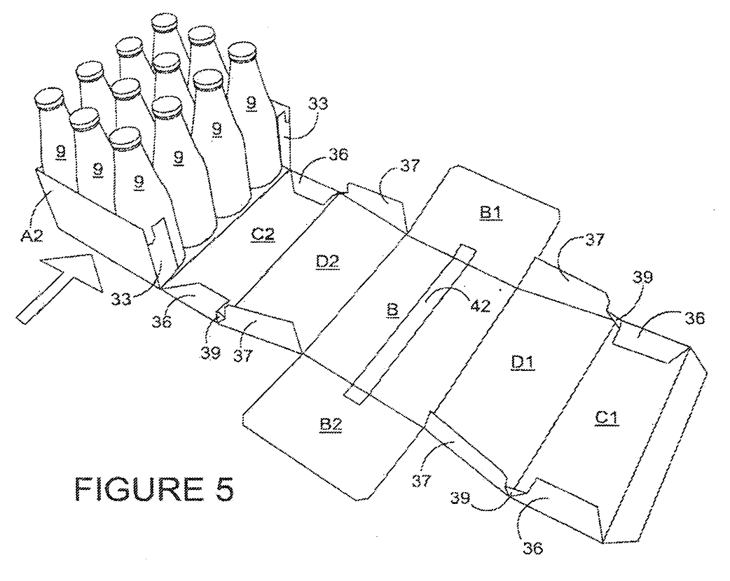

Referring to FIG. 5, end flaps 36, of the lower end panels C2 and C1 are folded 180° inwards using for example wheels (not shown). A spot of glue (not shown) may be applied to the side of the flaps 36 that confront the panels C2, C1. This simplifies keeping the end flaps 36, folded without the need for guides. At this stage, a handle tape 42 is glued to the inside of the top panel B in the vicinity of a pre-cut handle (not shown) that is provided in panel 8 of the blanks.

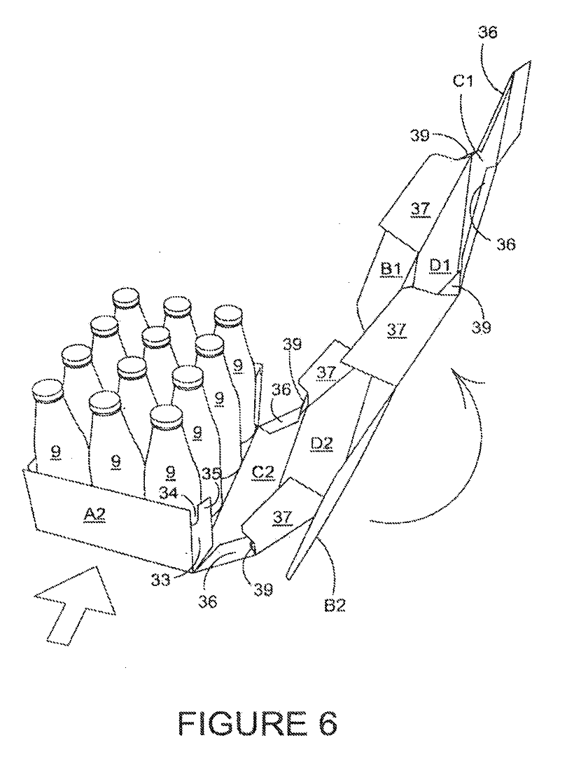

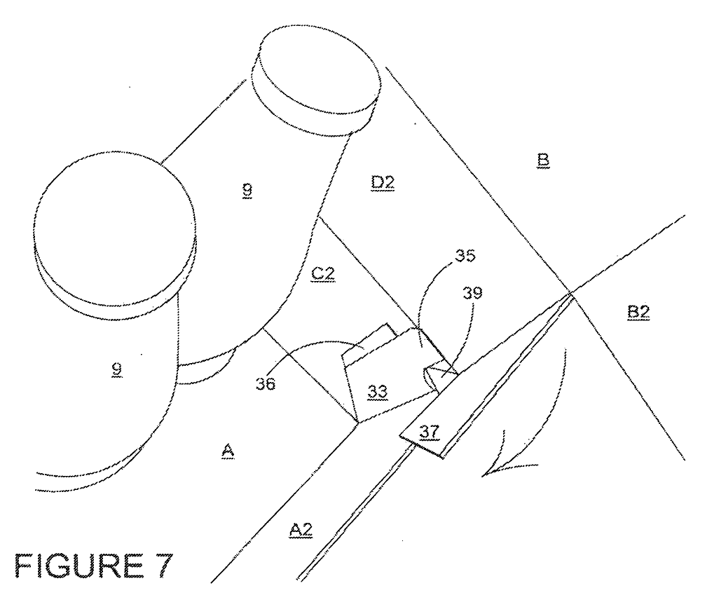

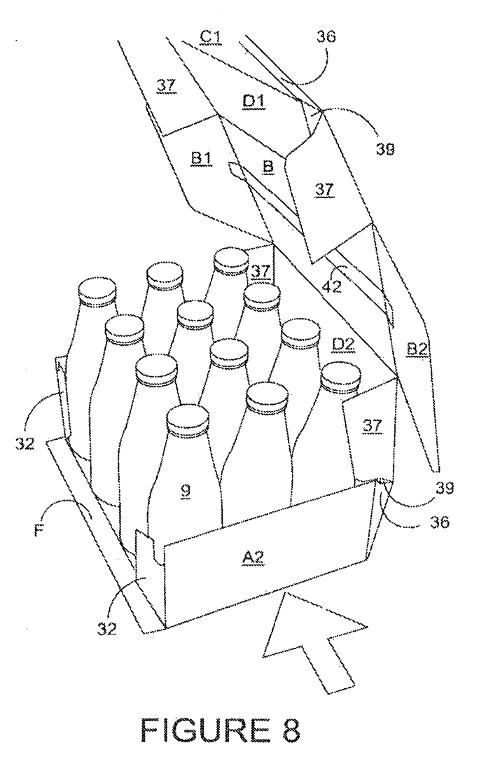

Referring to FIGS. 5 and 6 folding the end flaps 36, and gluing them to panels C1, C2 causes the end flaps 37 to assume a position 90° to the panels D1, D2 by virtue of the gussets 39 folding along the fold lines 40, 41. Further lifting of the blank 10 upwards from the right, causes the blank 10 to fold about fold lines 14 and 15. This causes the gussets 39 to engage the slots in the flaps 33 of the end panels A1, A2 (as shown in FIGS. 7 and 8) and enables the gussets 39 to be pushed into the respective slots 34. The hooks 35 further restrain the gussets 39 in the slots 34. This action holds the lower side panel C2 in place relative to the lower end panels A1 and A2 without glue.

Further folding of the carton blank 10, bends the carton about the fold line 15 that lies between the lower side pane; C2 and the upper side panel D2. During this folding step, the flaps 37 are brought into contact with the inside surfaces of the top edge of the bottom end panels A1, A2.

The top panel B and the second upper sidewall D1 and lower sidewall C1 are then folded into place by folding them about the appropriate fold lines 16, 17 and 18 between the panels whilst tucking the flaps 37 behind the tops of the end panels A1 and A2. During these folding steps the second set of gussets 39 are folded inwards and caused to engage the second set of slots 34 in the flaps 32 of the bottom end panels A1, A2. Again the hooks 35 help to restrain the gussets 39 in the slots 34. This action secures the upper and lower side walls D1, C1 and bottom end panels A1 and A2 in place.

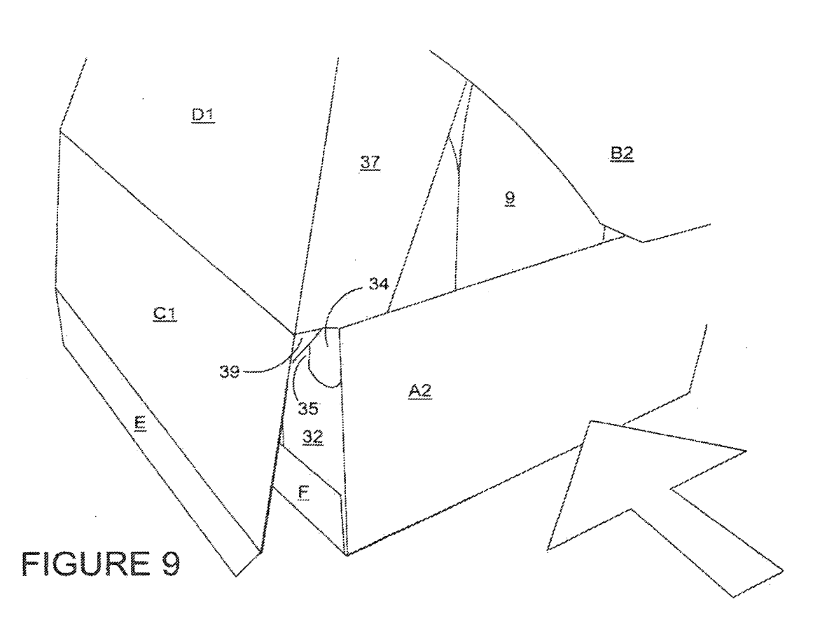

Finally, the panel F is folded upwards inside side panel C1 (see FIG. 9) and the panel E is folded under the bottom panel A and glued to the bottom panel A.

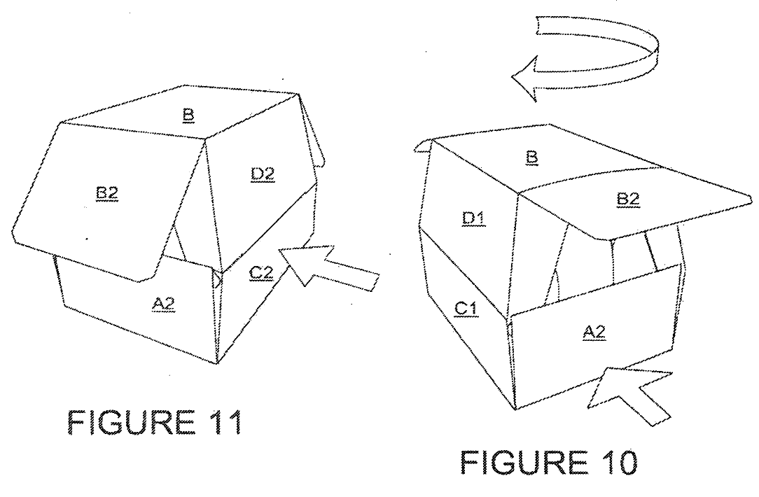

Completion of the carton is achieved by moving the assembled carton 41 to a compression and gluing station and appropriately rotating the carton as shown in FIGS. 10 and 11 to enable the top side ends 81, 82 to be glued to the bottom end panels A1, A2 and the flaps E and F to be glued to the respective panels A and C1. During the lest mentioned folding step the top end panels B1, B2 ate pre-glued and positioned over the outside of the bottom end panels A1. A2. (as shown in FIG. 11), to produce a gable-end top carton having tapering upper sides as shown in FIG. 9 (or similar primary packaging containers such as cans).

In an alternative-embodiment the panels de-fining the carton may be formed in the blank 10 in alternative configurations.

For example, panels D1 and C1 may be hinged along a fold line to base panel A such that the side panels D1/C1, D2/C2 are symmetrically disposed about the base panel A. It will be appreciated that the skilled man would adjust the location of securing panels E and F accordingly.

In further alternative embodiments one of the panels may be composite in structure, for example panel B forming the top panel may be formed from a first part hinged to panel D2 and second part hinged to panel D1, the first and second part being assembled in overlapping relationship. Accordingly the top end panels B1 and B2 may be composite in structure.

In yet another alternative embodiment it is envisaged that flaps 33 and the adjacent end flaps 36 may be coupled by a hinged connection such as one or more fold lines connecting therebetween or one or more gusset panels hingedly connected there between. For example, the cut line 43 as shown in FIG. 2 may be replaced by a fold line. This would further simplify the assembly process when carried out in a straight line packaging machine or robotic assembly system.

It will be recognised that as used herein, directional references such as “top”, “bottom”, “front”, “back”, “end”, “side”, “inner”, “outer”, “upper” and “lower” do not limit the respective panels to such orientation, but merely serve to distinguish these panels from one another. Any reference to “fold lines” should be construed as embracing one or more of the following, a score line, a perforated line, or other form of a line of weakness, about which the blank can be folded without departing from the scope of the invention.

Upon reading the foregoing it will be obvious to one skilled in the art that the invention may be applied to a wide range of carton types and is not limited in its application to fully-enclosed gable-ended cartons of the type illustrated.

The use of glue to secure end flaps 36 onto the lower side panels Ca and C2 is optional and the flaps may be held by guides or other mechanisms known in the art during folding.

The use of a handle strep is entirely optional.

The specific shape, size and orientation of the slots 34, hooks 35 and gusset 39 may in other implementations of the invention vary from that illustrated herein. For example gusset 39 may comprise a further foldline, may be shaped other than triangular, for example may take a trapezoidal form and indeed may be spaced by a cut from the adjacent side panels C1/D1, C2/D2.

1-16. (canceled)

17. A carton comprising a plurality of panels and flaps separated by fold lines that define edges of the panels, at least a pair of adjacent ones of said flaps having at least one gusset panel hinged between said adjacent flaps of said pair, at least one of said flaps excluding said pair being provided with a slot for receiving said at least one gusset panel so that said at least one gusset panel is retained by said slot whereby at least two of said panels of the carton are held together.

18. A carton according to claim 17 wherein the carton is formed from a blank comprising a linear series of panels for forming a tubular structure, at least one end closure panel hinged to a first panel of said panels of said linear series for at least partially closing an open end of said tubular structure and a first end closure flap hinged to a second panel of said panels of said linear series adjacent said first panel and wherein said at least one gusset panel is hinged to said first end closure flap for being received in said slot, said slot being formed in a second end closure flap.

19. A carton according to claim 18 wherein said second end closure flap is hinged to a side edge of said at least one end closure panel.

20. A carton according to claim 18 wherein said first end closure flap is disposed between said second end closure flap and said second panel.

21. A carton according to claim 18 wherein said at least one gusset panel is disposed between and hinged to said first end closure flap and a third end closure flap, said first end closure flap being folded into parallel relationship with the second panel and the third end closure flap being folded into parallel relationship with said at least one end closure panel.

22. A carton according to claim 21 wherein said at least one end closure panel is secured to the third end closure flap.

23. A carton according to claim 21 wherein said at least one end closure panel forms a composite panel of the carton, said composite panel comprising a first part hinged to said first panel and a second part hinged to a third panel of said panels of said linear series, said first and second parts being secured in overlapping relationship.

24. A carton according to claim 17 wherein the carton is a closed-ended tubular carton, said slot being provided in a flap that is hinged to a panel that forms a lower end panel of the carton, and said at least one gusset is provided at an end of a selected one of said fold lines that defines an upper edge of a lower side panel of the carton.

25. A carton according to claim 24 wherein said flap is folded so as to be disposed inside said lower end panel of the carton whereby said slot is positioned adjacent a corner of the carton so as to receive said at least one gusset at the corner of the carton when said at least one gusset is pushed into said slot.

26. A carton according to claim 17 wherein the carton is cube shaped, said slot is provided in a flap that is folded to lie adjacent to an inside surface of a panel that forms a lower side panel of the carton whereby said slot is positioned adjacent a corner of the carton, and said at least one gusset is provided at an end of a selected one of said fold lines that defines an upper edge of said lower side panel of the carton.

27. A blank for forming a carton, comprising a plurality of panels and flaps separated by fold lines that define edges of said panels, at least a pair of adjacent ones of said flaps having at least one gusset panel hinged between said adjacent flaps of said pair, at least one of said flaps excluding said pair being provided with a slot for receiving the said at least one gusset panel so that said at least one gusset panel is retained by said slot to hold at least two of said panels together when the blank is erected into a carton.

28. A blank according to claim 27 wherein said plurality of panels, and flaps include, in sequence, a bottom flap, a bottom panel with bottom end panels positioned laterally of said bottom panel, a first lower side panel, a first upper side panel, a top panel, two top end panels placed laterally of said top panel, a second upper side panel and a second lower side panel.

29. A blank according to claim 28 wherein the bottom end panels each has two flaps and each of said two flaps has a slot for receiving one of said at least one gusset when the blank is folded to make a carton.

30. A method of manufacturing a packaging carton comprising the steps of:
(a) providing a pre-shaped carton blank cut from a sheet of flexible foldable material having a plurality of panels and flaps separated by fold lines that define edges of the panels, wherein a selected pair of the flaps incorporate therebetween a foldable gusset subtended by two fold lines, a further selected flap being provided with a slot which is dimensioned and positioned for receiving the gusset, the gusset being positioned on the blank relative to a slot so that when the blank is folded about the fold lines to form a carton, the gusset confronts the slot;
(b) folding the blank about the fold lines to bring the gusset into confrontation with the slot;
(c) inserting the gusset into the slot to hold adjacent panels of the carton together; and,
(d) gluing selected ones of the panels and flaps to other selected ones of the panels to form a carton.

31. A method according to claim 30 wherein one of the flaps of the pair is brought into a folded position wherein the one flap is held in a substantial face-contacting relationship with part of the remainder of the blank wherein the gusset and the other flap of the pair are folded out of the plane of the blank in response to folding movement of the one flap into the folded position, and wherein the other flap is held at about a right angle with respect to the plane of the blank when the one flap is in the folded position.

32. A method according to claim 30 wherein the carton blank comprises in sequence, a bottom flap, a bottom panel with end panels positioned laterally of the bottom panel, a first lower side panel, a first upper side panel, a top panel two top end panels placed laterally of the top panel, a second upper side panel and a second lower side panel, and the steps of folding the blank about the fold lines forms a closed-ended tubular carton.
